(19) United States
(12) Patent Application Publication
(10) Pub. No.: US 2025/0327541 A1
(43) Pub. Date: Oct. 23, 2025

(54) COUPLING BUSHING WITH FLEXIBLE ANGULAR POSITION AND ITS PRODUCTION METHOD

(71) Applicant: TI Automotive (Fuldabrueck) GmbH, Fuldabrueck (DE)

(72) Inventors: Iris BARTHEL, Schauenburg (DE); Kay Bube, Schenklengsfeld (DE); Reiner Rohde, Malsfeld (DE); Andre Haeckel, Waldeck (DE)

(21) Appl. No.: 19/186,974

(22) Filed: Apr. 23, 2025

(30) Foreign Application Priority Data
Apr. 23, 2024 (DE) 102024111390.1

(51) Int. Cl. F16L 37/53; F16L 37/12; F16L 43/00

(52) U.S. Cl. CPC F16L 37/53; F16L 37/1225; F16L 43/008

(57) ABSTRACT

A coupling bushing having a bushing body and a retainer. The bushing body includes a head portion and a sealing part. The head portion and the sealing part are manufactured separately from each other and are connected to each other at an angular position in a circumferential direction via a joint. The coupling bushing comprises a securing part for connecting the head part and the sealing part. The securing part defines an axially locked state in which the head part and the sealing part are axially locked to one another by the securing part. The coupling bushing is designed such that the establishment of the axially secured state is decoupled spatially and/or temporally from a tangential securing of the connection between the head part and the sealing part.

### RELATED APPLICATIONS

The present disclosure claims priority to and the benefit of German Application 10 2024 111 390.1, filed on Apr. 23, 2024, the entire contents of each of which are incorporated herein by reference.

### FIELD

The present disclosure relates to a coupling bushing comprising a bushing body and a retainer, and also to a production method for such a coupling bushing.

### BACKGROUND

Bushing bodies with a head part and a sealing part are known from practice. One important reason for providing a head part and a sealing part is that these can be combined with each other using a modular principle. This means that head parts with different shapes can be combined with different sealing parts without the need for a separate injection molding tool for each combination. The sealing part types differ from one another, for example, in terms of different angles in a longitudinal section. Other differences can be found in the design of the connecting section. For example, three head part types and seven sealing part types require a total of only ten injection molding tools and not 21. The modular principle consequently reduces the number of cost-intensive injection molding tools, so that the coupling bushings can be produced more economically.

A two-part bushing body of this kind is disclosed in DE 10 2016 111 194 A1. The head part has four securing parts in the form of latching arms that extend in the axial direction and comprise latching lugs that project radially outwards on their radially outer sides. The latching lugs engage in the sealing part from radially inward to radially outward and latch in each case in an associated complementary recess in the sealing part. The latching arms thereby produce a form fit in the radial direction with an inner side of the sealing part. In addition, the engagement of a latching lug in a corresponding recess creates a tangential and at the same time an axial form fit, so that the head part is connected to the sealing part in a practically play-free manner in the radial, tangential and axial directions.

The four latching lugs are offset equidistantly at 90° in the circumferential direction and tangentially to one another. The same applies to the recesses. This allows a total of four angular positions in the circumferential direction between the head part and the sealing part. Thus, the securing parts also act as angle-adjusting elements for defining tangential angular positions. However, we have discovered that these four angular positions are often insufficient.

### BRIEF SUMMARY

The present disclosure provides a coupling bushing having greater flexibility with regard to the number of angular positions in the circumferential direction and tangential direction. The coupling bushings have a larger number of tangential angular positions that can be provided. The coupling bushing or the bushing body or the securing part is/are designed such that the establishment of the axially secured state is decoupled spatially and/or temporally from a tangential securing of the connection between the head part and the sealing part.

The present disclosure is based on the insight that the number of tangential angle positions between the head and sealing parts is determined by the shape of the securing parts or latching lugs/latching arms on the head part from DE 10 2016 111 194 A1 and the associated exceptions on the sealing part. It was found that the latching lugs and latching arms cannot be reduced in size as much as desired in the tangential direction. The fragility of the securing parts or latching elements of the head part thus limits the number of tangential angular positions between the head and sealing parts.

The present disclosure provides a particularly advantageous remedy here, since the decoupling of the axially secured state from the tangential securing or anti-rotation device allows significantly smaller angle-adjusting elements. It was found that with such a decoupling, the tangential angle-adjusting element can be designed without latching elements for axial securing. The present disclosure results in the relatively long and problematically thin latching arms not being required.

The present disclosure is based in particular on the realization that the latching elements for axial securing are replaced by a separate securing part, in order to thereby decouple the axial securing from the tangential securing between the head and the sealing part from each other. This allows a relatively large number of relatively small angle-adjusting elements to be provided, which allow a corresponding number of angular positions-for example eight, ten, twelve or even more angular positions. This makes it possible to achieve tangential angular positions in steps of, for example, 45°, 36° or 30°. The result is a smaller angle setting and thus greater product variability. This solves the problem mentioned at the beginning.

The center axis of the coupling section defines an axial, a radial and a circumferential direction or tangential direction of the coupling section. The term “circumferential direction” is used below as a synonym for “tangential direction”. The various directions are preferably related to the coupling section of the bushing body, but can also refer to the connecting section in the case of a connecting section that is not angled away from the coupling section but extends straight or coaxially. Preferably, the directions also refer to the securing part, the retainer and/or to a/the coupling plug or to a section of the coupling plug, in addition to the coupling section, because these elements are conveniently arranged in the area of the coupling section.

The expression “axially inward” preferably means the axial direction from the coupling section in the direction to the connecting section. “Radially inward” is advantageously understood as a radial direction towards the center axis.

The axial securing or the axially secured state by the securing part is preferably understood to mean that axial movement between the head part and the sealing part relative to each other is prevented, so that loosening of the connection between the head and sealing parts is prevented.

The connecting section can be connected or is connectable to a tube in a material-locking, force-locking and/or form-locking manner. The material lock can be produced, for example, by means of welding or gluing. The connecting section can be connected to an aggregate (e.g. a pump, a tank, a valve or the like) in a material-locking, force-locking and/or form-locking manner. In particular, the material-locking connection can be formed integrally with the unit. The term “integrally” preferably means that the material bond is produced by means of injection molding, so that the connecting section is a component of at least one injection-molded part of the aggregate.

According to a preferred embodiment, the coupling bushing or bushing body and/or the securing part is/are designed such that the axially secured state-at least in sections in the circumferential direction and preferably over a complete circumference of the sealing part-can be produced independently of the angular position between the head part and the sealing part. This preferably means that the production of the axially secured state—preferably by means of a radial insertion movement of the securing part—can be carried out at least in sections in the circumferential direction in a stepless or continuous manner on the sealing part. The sealing part may, for example, have a groove or shoulder for engagement with the securing part, the groove or shoulder extending at least in sections along a circumference and preferably along a complete circumference of the sealing part. The extension of the groove or shoulder along a complete circumference allows any rotation of the sealing part relative to the head part, so that the number of angular positions depends only on the number of angle-adjusting elements or complementary angle-adjusting elements and not, for example, on the securing part.

The sealing part preferably includes at least one angle-adjusting element and, more preferably, a plurality of angle-adjusting elements for adjusting the angular position between the sealing part and the head part. This allows a specific, predetermined angular position to be set very easily and precisely at the same time. It is advantageous if the head part preferably has at least one complementary angle-adjusting element complementary to the angle-adjusting element. The number of angle-adjusting elements or complementary angle-adjusting elements conveniently defines the number of angle settings. The angle-adjusting elements or complementary angle-adjusting elements are preferably designed as projections or as recesses complementary to the projections. According to one embodiment, the at least one angle-adjusting element is a projection that extends radially outwards and the complementary angle-adjusting element is a recess that is complementary to the projection. The at least one angle-adjusting element is advantageously arranged on an outer side of the sealing part. The at least one complementary angle-adjusting element is preferably arranged on an inner side of the head part.

It is advantageous if the angle-adjusting elements are designed to be identical to one another. It is advantageous if the complementary angle-adjusting elements are designed to be identical to one another. This allows the free selection of defined angular positions via the angle-adjusting elements or complementary angle-adjusting elements. It is preferred that the angle-adjusting elements or complementary angle-adjusting elements are distributed equidistantly around a circumference of the sealing part or the head part. It is advantageous if the number of angle-adjusting elements corresponds to the number of complementary angle-adjusting elements or the number of angular positions.

Preferably, the sealing part comprises at least 5, 6, 7 or 8 angle-adjusting elements. Preferably, the head part comprises at least 5, 6, 7 or 8 complementary angle-adjusting elements. This allows for a relatively large number of angular positions and thus a large flexibility and selection of available angular positions. It is possible that only a smaller number of angle-adjusting elements are opposed by a larger number of complementary angle-adjusting elements and vice versa. The bushing body is advantageously designed such that the at least one angle-adjusting element or the angle-adjusting elements and the at least one complementary angle-adjusting element or the complementary angle-adjusting elements allow at least 5 or 6 or 7 or 8 defined angle settings. The number of angular positions is preferably finite. The adjustment of the angular position is preferably graduated.

The connection between the head part and the sealing part is preferably provided by a reversible connection between the bushing body and the securing part. This makes it possible to open the bushing body subsequently, allowing, for example, a sealing ring to be replaced for the purpose of maintenance or repair.

The coupling bushing is preferably designed such that the securing part can be inserted in the radial direction into the bushing body or into a securing groove, respectively, in order to establish the axially secured state. This allows the use of a relatively simple assembly device, which inserts the securing part into the bushing body, due to the purely translational, rectilinear movement.

According to a preferred embodiment, the bushing body has a securing groove, wherein the securing part and/or the bushing body is/are preferably configured such that the securing part engages at least partially in the securing groove when it is inserted into the bushing body and/or during the axially secured state. The provision of a securing groove allows for an axially very compact securing part, so that the coupling bushing requires hardly any additional space in the vehicle due to the provision of a securing part decoupled from the angle-adjusting elements.

The head part advantageously has a first section of the securing groove. Preferably, the sealing part comprises a second section of the securing groove. It is preferable that the first section of the securing groove only occupies part of the circumference of the head part. It is advantageous that the second section of the securing groove extends at least partially around the sealing part, and preferably completely. The securing part can enter into a form fit, at least in sections in the circumferential direction, in at least one axial direction, preferably in the axially inward direction and in the axially outward direction, with the securing groove and/or with the first section and/or the second section of the securing groove. It is desirable that a/the U-base of the securing part and/or free ends of U-legs of the securing part are/is located in the first section when the bushing body or the coupling bushing is in the axially secured state. In a particularly preferred embodiment, a/the main portion of one or both of the U-legs of the securing part is/are arranged in the second section of the securing groove when the bushing body or the coupling bushing is in the axially locked state.

In a preferred embodiment, the securing part will be/is latched in the securing groove. According to a preferred embodiment, the bushing body and/or the head part and/or the securing part comprises a fixing element-in particular a latching element or clamping element-for fixing the securing part in the securing groove. This allows the securing part to be permanently fixed to the bushing body or in the securing groove, whereby this can be achieved by only a translational movement of the assembly device and in particular during the insertion movement of the securing part. The fixing element can be a locking projection or a clamping point. The fixing element can be arranged on the securing groove, in particular on the first section of the securing groove. It is preferred that the fixing element engages on a/the U-base of the securing part.

According to a preferred embodiment, the securing part is manufactured separately from the sealing part and/or separately from the head part. Preferably at least a part of the securing part and more preferably the whole of the securing part is movable in the axially secured state relative to the bushing body and/or the sealing part and/or the head part. The whole of the securing part can be movable relative to the bushing body and/or the sealing part and/or the head part, for example by being reversibly releasable from a latched state in the bushing body. A part of the securing part can be movable relative to the bushing body or the sealing part or the head part, in that, despite irreversible engagement in the bushing body, it has a leg that can be moved or easily spread, for example by hand or tool.

The securing part and/or the bushing body are/is particularly advantageously designed such that, in the secured or locked state, the securing part is at least partially and preferably completely recessed into the bushing body. The preferred complete recessing of the securing part in the bushing body serves to facilitate assembly and to prevent unintentional release of the securing means after assembly has been carried out. The securing part ensures increased security of the connection between the head and sealing part due to the recessing.

The securing part is advantageously of U-shaped design. This allows a particularly compact design of the securing part with only a small axial extent with a simultaneously reliable securing function. It is preferred that the securing part has two U-legs and a U-base. The U-legs each advantageously include a free end. Each of the two U-legs of the securing part advantageously includes a main section between the respective free end and the U-base. The securing part can include expansions at the free ends of the U-legs in order to ensure a better insertion assembly of the securing part. The expansions at the open ends of the holding clip are preferably to be understood as outward bends or kinks. The securing part may comprise a bulge for easier release of the securing part.

It is desirable that the securing part comprises metal, in particular steel. It is particularly desirable that the securing part comprises a wire. It is highly desirable that the securing part is formed as a wire bow. In this way, the strength and robustness of metals can be used to provide a compact and resilient securing part.

It is particularly advantageous that the retainer is formed as a wire bow. It is possible for the retainer to be essentially U-shaped or to extend all the way around. Preferably, the retainer is U-shaped and has two U-legs and a U-base. It is advantageous that the retainer is formed separately from the bushing body and the head part and the sealing part. Preferably the entire retainer or at least part of the retainer is movably mounted in the bushing body or head part. The retainer advantageously defines an insertion direction along which the retainer is inserted into the bushing body or the head part. The retainer is advantageously designed to be VDA-compliant.

The head part and/or the sealing part preferably comprises a plastic. It is particularly preferred that the head part and/or the sealing part is/are injection molded. This allows for a cost-effective production of the bushing body.

The coupling bushing preferably includes a sealing ring for fluid sealing between the coupling bushing and the coupling plug. The bushing body advantageously includes a sealing groove in which the sealing ring is preferably arranged. The sealing groove may include an axially inner groove wall and/or an axially outer groove wall and/or a groove base. The sealing ring may comprise an elastomer.

Preferably, the coupling bushing or the bushing body comprises a decoupling ring for decoupling the head part from the sealing part. This is intended to create a coupling bushing that, on the one hand, offers a high degree of flexibility with regard to the rotation of the head part relative to the sealing partand, on the other hand, is relatively easy to insert when the coupling plug is inserted. The smooth insertion of the coupling plug is achieved by means of a sealing ring which is not arranged or shaped purely rotationally symmetrically, but extends beyond its axial thickness in the axial direction due to the non-rotationally symmetrical arrangement. As a result, the required insertion force is somewhat stretched and at the same time somewhat reduced over the insertion path.

The decoupling ring is preferably manufactured separately from the head part, so that the decoupling ring is preferably not integrally connected to the head part. It is advantageous if the decoupling ring, with an axially inward-facing rear side, forms at least a portion of the axially outer groove wall of the sealing groove. Preferably, the decoupling ring is in a form-fitting connection with the sealing part in the circumferential direction, in particular via a tongue and groove connection. This enables a defined alignment of the decoupling ring in the circumferential direction relative to an inner groove wall or to the sealing part. It is preferred that the decoupling ring comprises an angle-fixing element. It is advantageous that the sealing part has a complementary angle-fixing element.

It is advantageous that the groove base and/or the inner groove wall and/or the outer groove wall of the sealing groove, as seen in a longitudinal section of the coupling bushing, has/have a curved contour, at least in sections. This enables the sealing ring to be held more securely. It is preferred that the curved contour of the inner groove wall, as seen in longitudinal section, comprises an axially inward bulge. It is possible that the outer groove wall comprises a straight contour or a contour that only extends in the radial direction. It is possible that the groove base, as seen in longitudinal section of the coupling bushing, has a contour that only extends in the axial direction.

The coupling bushing advantageously includes an indicator element for indicating a position of the coupling plug within the coupling bushing. This provides greater assembly reliability. It is possible that the coupling bushing is designed so that the indicator element indicates that the coupling plug has been fully inserted into the coupling bushing. According to one embodiment, the coupling bushing is designed in such a way that the indicator element indicates that the coupling plug has not been fully inserted into the coupling bushing.

The indicator element can provide a visual and/or haptic and/or electrical or electronic indicator signal. For example, the indicator element can be designed as a QR code and/or as an element protruding from the coupling body and/or as a radio signal. It is preferred that the indicator element comes into contact with the coupling plug directly or indirectly. It is possible that a sliding element on an outer side of the coupling body can only be displaced in the axial direction when the coupling plug is fully inserted, so that an indicator element in the form of an optical code, for example a QR code or a bar code, becomes visible to the user.

It is possible that the retainer has the indicator element, whereby the retainer or the indicator element can only be inserted into the coupling body when the coupling plug is fully inserted. It is possible that, if a coupling plug is not inserted, an electric circuit remains open or is closed, causing a chip to emit a corresponding radio signal and act as an indicator element.

The present disclosure also includes a fluid line, whereby the fluid line comprises a coupling bushing according to the disclosure and a tube. As a result, the fluid-technical complexity is shifted to the fluid line, so that the coupling plug can be designed much more simply. As a consequence, the units can be equipped with simple coupling plugs, whereby a clear separation of tasks between the different suppliers is ensured. It is preferred that the tube and/or the coupling body comprise at least 30 or 50 or 70 or 90 percent by weight plastic.

Preferably, the connecting section of the coupling body is formed as a plug-in portion. It is possible for the tube to be plugged onto the connecting section or into the connecting section. The connection of the tube to the connecting section is preferably designed to be force-locking and/or form-fitting and/or material-locking. For example, the tube can be placed on the connecting section by means of an interference fit, creating a force-locking and form-fitting connection. It is possible to insert the tube into a receiver of the connecting section in order to produce a material-locking connection in a second step.

The coupling bushing may be used in a vehicle, preferably in a land vehicle, more preferably in a road vehicle.

A method for manufacturing a coupling bushing includes that the coupling bushing or the bushing body or the securing part is/are designed such that the manufacture of the axially secured state is carried out after a tangential securing of the connection between the head part and the sealing part.

This achieves a temporal decoupling of the axial securing from a tangential securing, so that a spatial decoupling of these two securing actions is also possible. This in turn allows a delicate tangential securing with the simultaneous presence of a very robust axial securing.

### BRIEF DESCRIPTION OF THE DRAWINGS

The present disclosure will be explained in more detail below with the aid of four figures of an example. The following figures show

FIG. 1 an overview of a coupling bushing according to the invention,

FIG. 2 a longitudinal section through the coupling bushing from FIG. 1 in the assembled state,

FIG. 3 a rear view of the coupling bushing according to the invention from FIGS. 1 and 2,

FIG. 4 an overview of the coupling bushing from FIGS. 1 to 3 with the head part and the retainer hidden.

### DETAILED DESCRIPTION

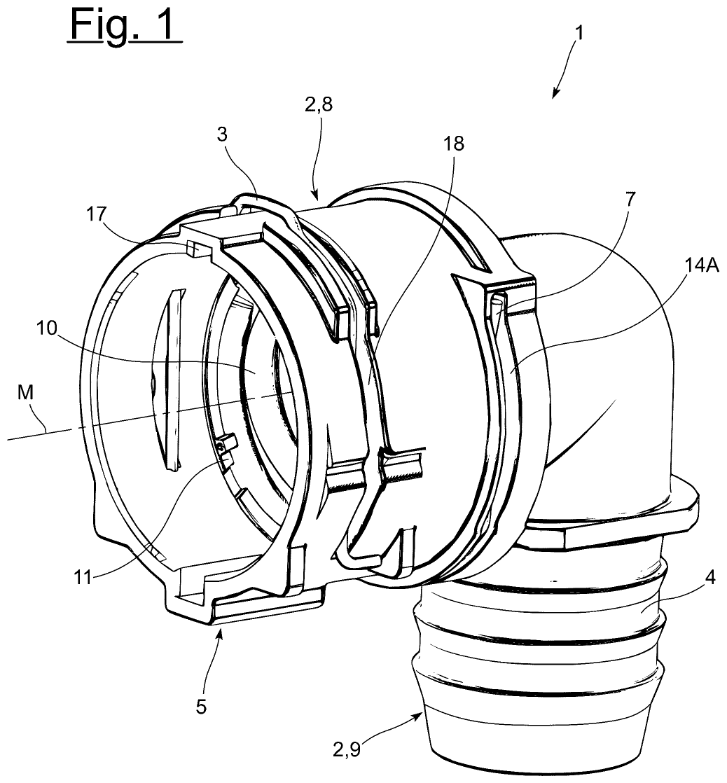

According to FIG. 1, the coupling bushing 1 comprises a bushing body 2 as well as a retainer 3 and a sealing ring 10. The bushing body 2 advantageously includes a sealing groove 12 in which the sealing ring 10 is arranged. The retainer 3 of this initial example is preferably VDA-compliant and can be designed as a U-shaped wire bracket with a U-base and two U-legs. The sealing ring 10 preferably comprises an elastomer for the force-locking sealing of the coupling bushing 1 with respect to a complementary coupling plug, which is not shown here.

The coupling plug can have a groove or a shoulder on its outside, by means of which the coupling plug can engage with the retainer 3 in a known manner within the coupling bushing 1. It is preferred that the retainer 3 and/or the sealing ring 10 can be reversibly removed from the coupling bushing 1. The term “reversible” preferably means that they can be removed without being destroyed.

As can be seen from FIGS. 1 to 3, the bushing body 2 has a head part 8, a decoupling ring 11 and a sealing part 9. In this embodiment, the sealing ring 10 is preferably first inserted into the sealing part 9, whereupon the decoupling ring 11 is then expediently inserted into the sealing part 9 for the purpose of pre-fixing the sealing ring 10 and for the purpose of decoupling.

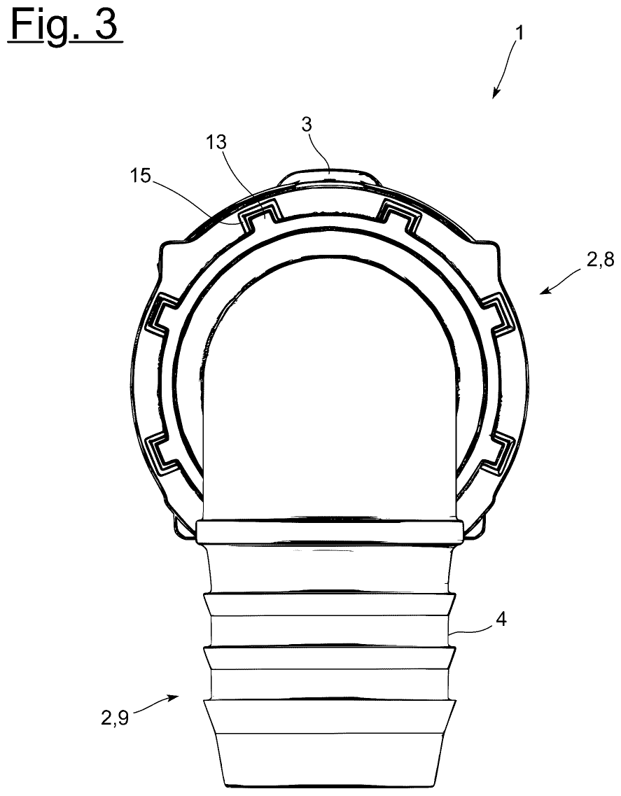

As shown in FIG. 3, the sealing part 9 advantageously comprises a plurality—for example eight-of angle-adjusting elements 13. Preferably, the head part 8 comprises a plurality—for example eight—of complementary angle-adjusting elements 15. In this embodiment, the angle-adjusting elements 13 are designed as projections which correspond with the complementary angle-adjusting elements 15 in the form of recesses. When the head part 8 and the sealing part 9 are brought together, it is preferred that the angle-adjusting elements 13 and the complementary angle-adjusting elements 15 interlock or mesh with each other. It is highly desirable that the head part 8 and the sealing part 9 can be combined with each other in a plurality of tangential positions or angular positions around the center axis M with the help of the angle-adjusting elements 13 or the complementary angle-adjusting elements 15. In the present embodiment, the sealing part 9 and the head part 8 can be attached to one another in 45° increments.

The securing part 7 is used to connect the head part 8 and the sealing part 9 in the axial direction and defines an axially secured state. It is preferable for the axially secured state to be achieved when the securing part 7 is fully inserted into the bushing body. The securing part 7 is preferably designed such that the establishment of the axially secured state by the securing part 7 in the circumferential direction is at least in sections and preferably over a whole periphery independent of the angular position between the head part 8 and the sealing part 9.

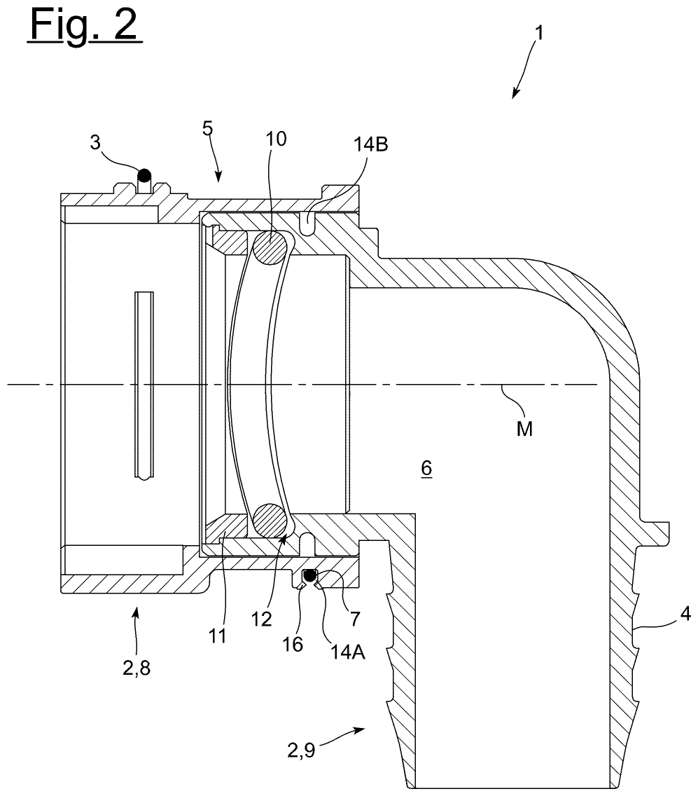

The securing means 7 preferably comprises metal and more preferably a steel and particularly preferably a wire. Particularly preferably, the securing part 7 is U-shaped and comprises a U-base and two U-legs. Preferably, the securing part 7 has expansions at free ends of the U-legs, in order to advantageously enable simple insertion of the securing part 7 into the securing groove 14A, 14B. As shown in FIGS. 1 and 2, the securing groove 14A, 14B, the bushing body 2 and/or the securing part 7 are preferably designed such that the securing part 7 is at least partially and preferably completely recessed in the bushing body 2 and/or the securing groove 14A, 14B in the axially secured state.

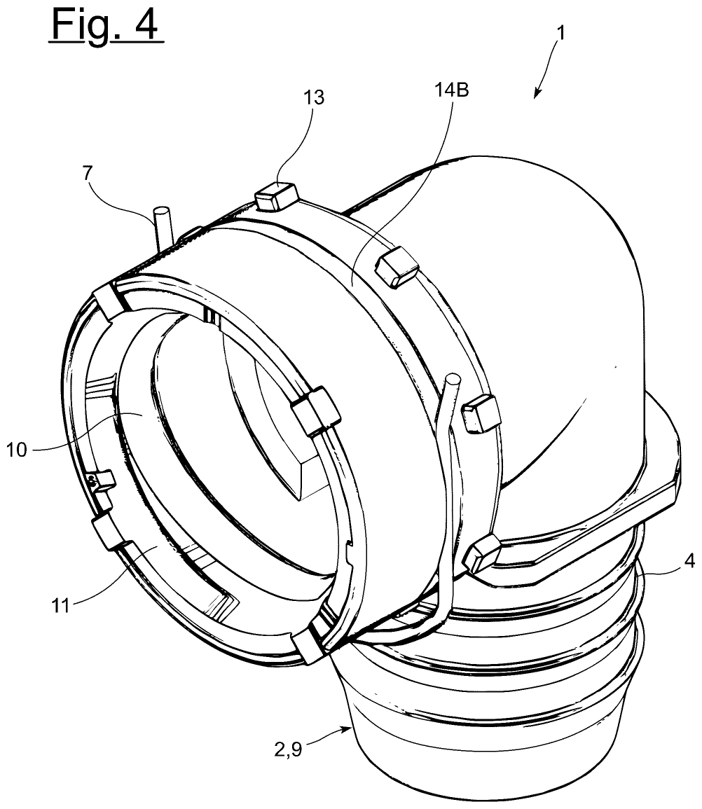

Preferably, and as can be seen in FIGS. 1 and 4, the securing part 7 of this embodiment is U-shaped. The securing part 7 is preferably introduced into the bushing body 2 to produce the axially secured state. For this purpose, the bushing body 2 advantageously has a securing groove 14A, 14B. It is preferred that at least a first section 14A of the securing groove 14A, 14B is arranged in the head part 8 and/or at least a second section 14B of the securing groove 14A, 14B is arranged in the sealing part 9. In the exemplary embodiment, the first section 14A of the securing groove 14A in the head part is designed to be only partially circumferential. The second section 14B of the securing groove 14A, 14B in the sealing part 9 is preferably designed to be completely circumferential.

The securing part 7 engages in the securing groove 14A, 14B for the purpose of axially securing the connection between the sealing part 9 and the head part 8. In order to favor the engagement of the securing part 7 in the securing groove 14A, 14B, the first section 14A of the securing groove 14A, 14B preferably has at least one fixing element 16, see FIG. 2. The fixing element 16 is advantageously a latching element and can in particular comprise two latching lugs. The fixing element 16 is advantageously designed such that it interacts in a fixing manner with the U-base of the securing part 7.

Preferably, the head part 8, the decoupling ring 11 and/or the sealing part 9 are each made of plastic and in particular by means of injection molding. The decoupling ring 11 is advantageously manufactured separately from the head part 8 and/or from the sealing part 9. The decoupling ring 11 advantageously comprises an angle-fixing element which corresponds with a complementary angle-fixing element of the sealing part 9.

The head part 8 may comprise a retainer receiver 18 in a known manner, which, as can be seen from FIGS. 1 and 2, can receive in particular the U-legs of the retainer 3. According to the invention, the head part 8 comprises at least part of a coupling section 5. The coupling section 5 may be defined in particular by the maximum axial extent of the coupling plug within the coupling socket 1 and, as can be seen in FIG. 2, may also extend into the sealing part 9.

It is possible that the head part 8 or the bushing body 2 comprises an anti-rotation device 17, which prevents the coupling plug from twisting in the bushing body 2. The anti-rotation device 17 may comprise at least one groove or one tongue and, according to FIG. 1, may in particular have two grooves.

According to the present disclosure, the sealing part 9 comprises a connecting section 4 for connection to a tube or an aggregate. The connecting section 4 may be designed for the still pending connection to a tube or an aggregate, but may also already have entered into a connection with a tube or aggregate. The connecting section 4 can be designed to be pushed on or inserted and may comprise a material bond, a force lock and/or a form lock. In the present embodiment according to FIGS. 1 to 4, the connecting section 4 is designed with barbs or ribs on the outside in order to securely fasten a tube or an aggregate that is pushed onto it. It is expedient that the connecting section 4 and the coupling section 5 are fluidically connected to one another by means of a fluid channel 6 of the bushing body 2, see FIG. 2.

In this embodiment, the coupling bushing 1 is angled in accordance with FIGS. 1 to 3, so that a center axis M of the coupling section 5 deviates from a center axis of the connecting section 4, not shown in the figures, in the longitudinal section of the coupling bushing 1. In particular, the center axis M and the center axis can form a right angle to one another. The angled section in the longitudinal section of the coupling bushing 1 is preferably realized in the sealing part 9, so that the head part 8 can be connected to a multiplicity of different sealing parts 9, each with different angled sections.

### LIST OF REFERENCE NUMBERS

1 Coupling bushing
2 Bushing body
3 Retainer
4 Connecting section of 2, 9
5 Coupling section of 2, 8
6 Fluid channel of 2
7 Securing part
8 Head part
9 Sealing part
10 Sealing ring
11 Decoupling ring
12 Sealing groove of 2
13 Angle-adjusting element of 9
14A First section of the securing groove 14A, 14B
14B Second section of the securing groove 14A, 14B
15 Complementary angle-adjusting element of 8
16 Fixing element
17 Anti-rotation device
18 Retainer receiver
M Center axis of 5

1. A coupling bushing comprising a bushing body and a retainer, the bushing body having a connecting section and a coupling section, the retainer being arranged in the coupling section, the coupling section being configured to receive a complementary coupling plug, the connecting section being connectable or connected to a tube or an aggregate, wherein a fluid channel of the bushing body fluidically connects the coupling section and the connecting section to one another, wherein a center axis of the coupling section defines an axial, a radial and a circumferential direction of the coupling section,
said bushing body having a head part and a sealing part, said head part and said sealing part being manufactured separately from each other and being connected or connectable to each other via a connection at an angular position in a circumferential direction, said head part at least partially comprising said coupling section, the sealing part at least partially comprising the connecting section, the coupling bushing comprising a securing part for connecting the head part and the sealing part, the securing part defining an axially secured state in which the head part and the sealing part are axially secured to one another by the securing part,
wherein the coupling bushing or the bushing body or the securing part is/are designed such that the establishment of the axially secured state is decoupled spatially and/or temporally from a tangential securing of the connection between the head part and the sealing part.

2. The coupling bushing according to claim 1, wherein the coupling bushing or the bushing body or the securing part is/are configured such that the axially secured state can be produced independently of the angular position between the head part and the sealing part—at least in sections in the circumferential direction and preferably over a complete circumference.

3. The coupling bushing according to claim 1, wherein the sealing part comprises at least one angle-adjusting element for adjusting the angular position between the sealing part and the head part, wherein the head part preferably comprises at least one complementary angle-adjusting element complementary to the angle-adjusting element.

4. The coupling bushing according to claim 1, wherein the coupling bushing is configured such that the securing part can be inserted or is inserted in the radial direction into the bushing body in order to establish the axially secured state.

5. The coupling bushing according to claim 1, wherein the bushing body has a securing groove, wherein the securing part and/or the bushing body is/are preferably configured such that the securing part engages at least partially in the securing groove when it is inserted into the bushing body and/or during the axially secured state.

6. The coupling bushing according to claim 1, wherein the securing part is manufactured separately from the sealing part and/or the head part and is preferably movable in the axially secured state relative to the bushing body and/or to the sealing part and/or to the head part.

7. The coupling bushing according to claim 1, wherein the securing part is U-shaped and is preferably formed as a wire bow.

8. The coupling bushing according to claim 1, wherein the retainer comprises metal and is preferably formed as a wire bow.

9. The coupling bushing according to claim 1, wherein the coupling bushing or the bushing body comprises a decoupling ring for decoupling the head part from the sealing groove.

10. A method for producing a coupling bushing, wherein the coupling bushing has a bushing body and a retainer, wherein the bushing body comprises a connecting section and a coupling section, wherein the retainer is arranged or can be arranged in the coupling section, the coupling section being designed to receive a complementary coupling plug, the connecting section being connectable or connected to a tube or an aggregate, wherein a fluid channel of the bushing body fluidically connects the coupling section and the connecting section to one another, wherein a center axis of the coupling section defines an axial, a radial and a circumferential direction of the coupling section,
said bushing body comprising a head part and a sealing part, said head part and said sealing part being manufactured separately from each other and connected to each other via a connection at an angular position in a circumferential direction, said head part at least partially comprising said coupling section, the sealing part at least partially comprises the connecting section, the coupling bushing comprising a securing part for connecting the head part and the sealing part, the securing part defining an axially secured state in which the head part and the sealing part are axially secured to one another by the securing part,
wherein the coupling bushing or the bushing body or the securing part is/are designed such that the axially secured state is established after the connection between the head part and the sealing part has been tangentially secured.
